(19) United States
(12) Patent Application Publication
(10) Pub. No.: US 2017/0060436 A1
(43) Pub. Date: Mar. 2, 2017

(54) TECHNOLOGIES FOR MANAGING A RESERVED HIGH-PERFORMANCE MEMORY REGION OF A SOLID STATE DRIVE

(71) Applicant: Intel Corporation, Santa Clara, CA (US)

(72) Inventors: Sanjeev N. Trika, Portland, OR (US); Knut S. Grimsrud, Forest Grove, OR (US); Piotr Wysocki, Gdansk (PL)

(21) Appl. No.: 14/843,581

(22) Filed: Sep. 2, 2015

(51) Int. Cl. G06F 3/06; G06F 11/20

(52) U.S. Cl. CPC G06F 3/0611; G06F 3/0659; G06F 3/0685; G06F 3/0619; G06F 11/2015; G06F 2201/805

(57) ABSTRACT

Technologies for establishing and managing a high-performance memory region of a solid state drive include reserving a region of a volatile memory of the solid state drive for storage of host data. Memory accesses received from a host may be directed toward the reserved region of the volatile memory or toward a non-volatile memory of the solid state drive. Due to the structure of the volatile memory, memory accesses to the reserved region may exhibit lower access timing relative to memory accesses to the non-volatile memory. As such, the reserved region may be utilized as storage space for journaling and logging of data and/or other applications. Upon shutdown or a power failure event, data stored in the reserved region of the volatile memory is copied to the non-volatile memory and subsequently reinstated to the volatile memory upon the next initialization event.

### BACKGROUND

Many software applications utilize some form of data journaling or logging to ensure system reliability, data redundancy, catastrophe recovery, and/or improve the overall functionality of the software. For example, typical database systems often store multiple copies of the managed data, along with associated metadata, to facilitate a rollback to a previous context point in the event of a system failure or unrecoverable error during a write cycle. Similarly, many redundant array of independent disks (RAID) systems buffer writes, along with associated metadata, to improve performance of the RAID system and facilitate recovery of data should an error occur. Such applications typically duplicate the data by saving it to a non-volatile memory, such as a battery-backed volatile memory or non-volatile dual in-line memory module (NVDIMM), or other non-volatile memory solution. However, such solutions are typically expensive relative to the system and/or are unreliable over long periods of time.

Solid state drives (SSDs) are data storage devices that rely on memory integrated circuits to store data in a non-volatile or persistent manner. Unlike hard disk drives, solid state drives do not include moving, mechanical parts, such as a movable drive head and/or drive spindle. As such, solid state drives are generally more durable to physical contact (e.g., bumping) during operation and operate more quietly than traditional disk drives. Due to the reliance on solid state memory devices to store data, solid state drives generally exhibit lower access time relative to typical disk drives.

A typical solid state drive includes a large amount of non-volatile memory, which is oftentimes based on NAND flash memory technology, although NOR flash memory may be used in some implementations. The majority of data stored on a solid state drive is stored in the non-volatile memory for long-term storage. To further improve the access times, some solid drives may also include a small amount of volatile memory, which is generally embodied as dynamic random-access memory (DRAM) and has faster access times than the relatively slower NAND flash memory. During operation, the solid state drive may utilize the volatile memory as a cache to store data waiting to be written to the non-volatile memory or read from the solid state drive. Additionally, the volatile memory may be used to store a working copy of the metadata used by the solid state drive to control the operations thereof, such as an indirection table, wear leveling information, error correction tables, and so forth.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a solid state drive configured to reserve and manage a high-performance memory region;

FIG. 2 is a simplified block diagram of at least one embodiment of a computing system including the solid state drive of FIG. 1;

FIG. 3 is a simplified block diagram of at least one embodiment of an environment that may be established by the solid state drive of FIG. 1;

FIG. 4 is a simplified block diagram of at least one embodiment of a method for initialization that may be executed by the solid state drive of FIG. 1;

FIG. 5 is a simplified block diagram of at least one embodiment of a method for managing storage access requests that may be executed by the solid state drive of FIG. 1;

FIG. 6 is a simplified block diagram of at least one embodiment of a method for handling a power failure event that may be executed by the solid state drive of FIG. 1; and

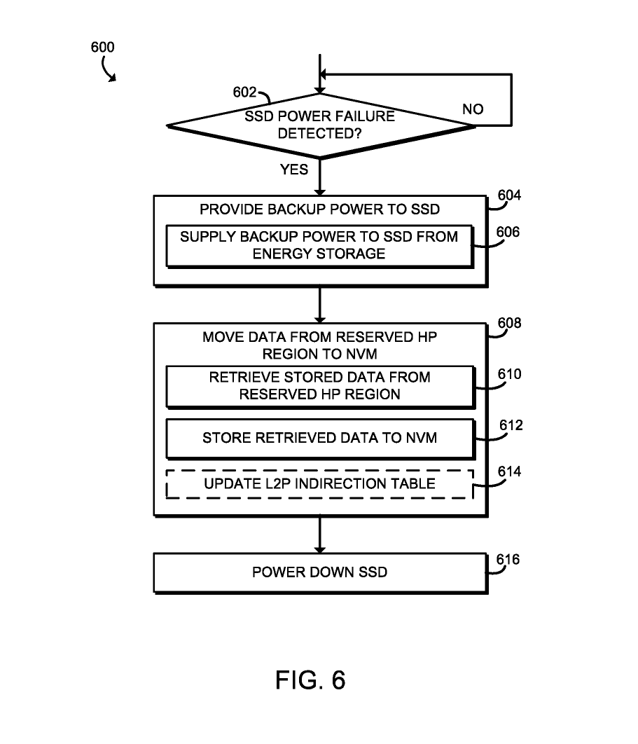

FIG. 7 is a simplified block diagram of at least one embodiment of a method for accessing a reserved high-performance memory region that may be executed by a host of the computing system of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

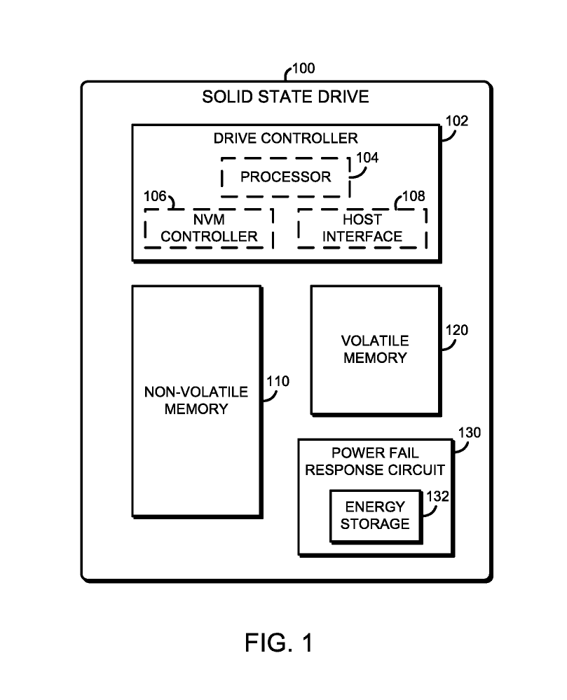

Referring now to FIG. 1, an illustrative solid state drive 100 includes a drive controller 102, a non-volatile memory 110, and a volatile memory 120. As discussed in more detail below, in use, the drive controller 102 is configured to reserve a region of the volatile memory 120 as a high-performance memory region, which may be used by a host to store important and/or often-accessed data (e.g., during journaling or logging procedures). Because the reserved region is established in the volatile memory 120, the memory accesses to the reserved region are typically of a higher speed and endurance relative to memory accesses of data stored in the non-volatile memory 110.

As discussed in more detail below, the drive controller 102 is configured to expose the reserved region of the volatile memory 120 to host applications, and the host application may access the reserved region by directing memory accesses to the reserved region. Because the data stored in the reserved region of the volatile memory 120 may be of an important nature, the drive controller 102 is also configured to copy any data presently stored in the reserved region of the volatile memory 120 to the non-volatile memory 110 in response to any shutdown requests. Additionally, to protect against unforeseen power interruptions or failures, the solid state drive 100 includes a power fail response circuit 130, which is configured to supply power to components of the solid state drive 100 in the event of a power failure to allow the drive controller 102 to copy data stored in the reserved region of the volatile memory 120 to the non-volatile memory 110 in the event of such unforeseen power interruptions.

The drive controller 102 of the solid state drive 100 may be embodied as any type of control device, circuitry, or collection of hardware devices capable of establishing and managing the reserved region of the volatile memory 120 and performing the functions described herein. In the illustrative embodiment, the drive controller 102 includes a processor or processing circuitry 104, a non-volatile memory controller 106, and a host interface 108. Of course, the drive controller 102 may include additional devices, circuits, and/or components commonly found in a drive controller of a solid state drive in other embodiments.

The processor 104 may be embodied as any type of hardware processor or processing circuitry capable of performing the functions described herein. For example, the processor 104 may be embodied as a single or multi-core processor(s), digital signal processor, microcontroller, or other processor or processing/controlling circuit. In the illustrative embodiment, the processor 104 controls and manages operation of other components of the drive controller 102.

Similar to the processor 104, the non-volatile memory controller 106 may be embodied as any type of hardware processor, processing circuitry, or collection of devices capable of managing the non-volatile memory 110. In use, the non-volatile memory controller 106 manages read and write access to the non-volatile memory 110. Additionally, the non-volatile memory controller 106 may manage various metadata associated with the non-volatile memory 110 including, but not limited to, a logical-to-physical indirection table, which may be temporarily stored in the volatile memory 120 during operation of the solid state drive 100.

In some embodiments, the processor 104 and the non-volatile memory controller 106 may be embodied as the same hardware processor, processing circuitry, and/or collection of devices. Additionally, in some embodiments, the processor 104 and the non-volatile memory controller 106 may form a portion of a System-on-a-Chip (SoC) and be incorporated, along with other components of the drive controller 102, onto a single integrated circuit chip.

The host interface 108 may also be embodied as any type of hardware processor, processing circuitry, input/output circuitry, and/or collection of components capable of facilitating communication of the solid state drive 100 with a host device or service (e.g., a host application). That is, the host interface 108 embodies or establishes an interface for accessing data stored on the solid state drive 100 (e.g., stored in the non-volatile memory 110 or the volatile memory 120). To do so, the host interface 108 may be configured to utilize any suitable communication protocol and/or technology to facilitate communications with the solid state drive 100. For example, the host interface 108 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology.

The non-volatile memory 110 may be embodied as any type of non-volatile memory capable of storing data in a persistent manner. In the illustrative embodiment, the non-volatile memory 110 is embodied as NAND flash memory, but other types of non-volatile memory may be used in other embodiments including, but not limited to, NOR flash memory, phase change memory (PCM), electrically erasable programmable read-only memory (EEPROM), resistive memory, nanowire memory, three-dimensional cross point memory arrays ferro-electric transistor random access memory (FeTRAM), magnetoresistive random access memory (MRAM), spin transfer torque MRAM, and/or other non-volatile memory. It should be appreciated that the non-volatile memory 110 may be formed from multiple, discrete memory devices (e.g., multiple NAND circuit chips or dies), which may be managed and accessed by the non-volatile memory controller 106 in a parallel manner to increase the memory access speed of the solid state drive 100. In such embodiments, a memory band of physical memory may stretch across multiple, discrete memory devices. Additionally, virtual memory blocks may be located on multiple, discrete memory devices of the non-volatile memory 110.

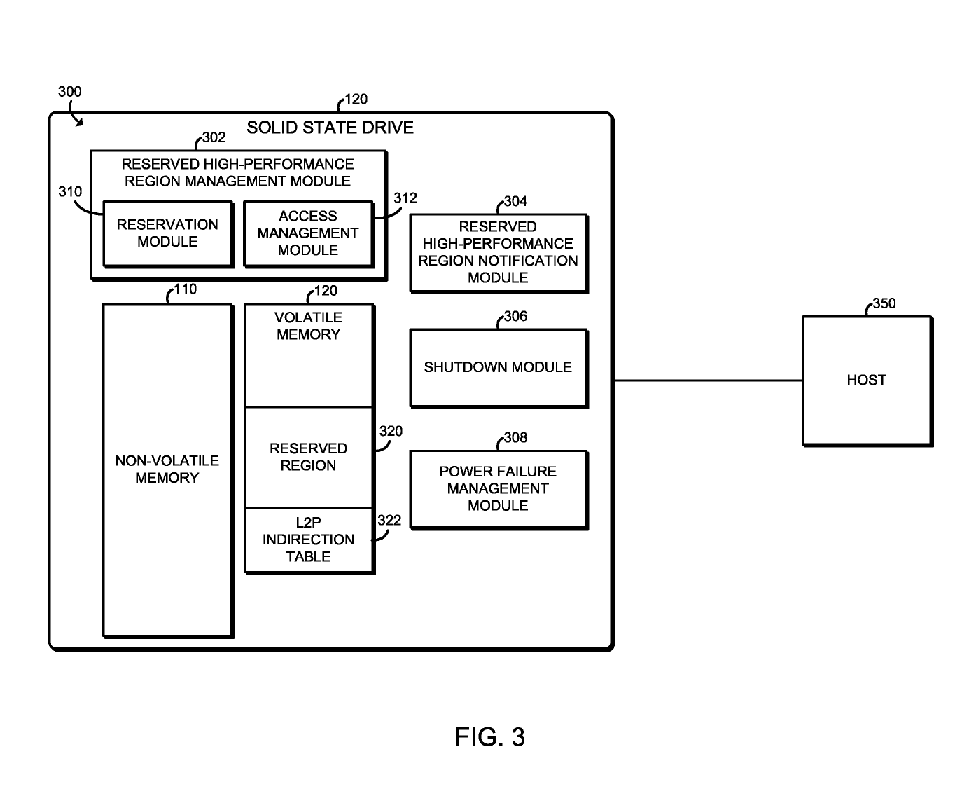

The volatile memory 120 may be embodied as any type of volatile memory capable of storing data while the solid state drive 100 is operational. In the illustrative embodiment, the volatile memory 120 is embodied as dynamic random access memory (DRAM), but may be embodied as other types of volatile memory in the other embodiments. In the illustrative solid state drive 100, the volatile memory 120 may have an increased capacity relative to typical solid state drives to accommodate the reserved, high-performance memory region. In some embodiments, for example, the size of the reserved memory region of the volatile memory 120 may be substantially similar to the size of the non-volatile memory 110 as described in more detail below. It should be appreciated that due to the type of memory of the volatile memory 120 (e.g., DRAM memory), memory accesses to the volatile memory 120, such as to the reserved memory region, may be faster and exhibit higher endurance than those to the non-volatile memory 110. In addition to the reserved, high-performance memory region, the volatile memory 120 may also store various metadata associated with the data stored in the non-volatile memory 110, such as a logical-to-physical indirection table 322 (see FIG. 3).

As discussed above, the illustrative solid state drive 100 also includes the power fail response circuit 130, which is configured to provide backup power to certain components of the solid state drive 100 for a period of time in the event that power to the solid state drive 100 is unexpectedly lost or interrupted. To do so, the power fail response circuit 130 includes an energy storage 132, which may be embodied as any type of energy storage device or devices capable of providing power to components of the solid state drive 100 for a period of time. In the illustrative embodiment, the energy storage 132 is embodied as a bank of capacitors, which are charged during operation and from which energy can be extracted in the event of a power interruption. In other embodiments, the energy storage 132 may be embodied as, or otherwise include, other types of energy storage devices such as backup batteries. In the illustrative solid state drive 100, the size and/or available power of the energy storage 132 may be greater than backup circuits of typical solid state drives due to the increased amount of data potentially stored on the volatile memory 120 in the reserved region, which may require additional time and/or power to move to the non-volatile memory 110 in the event of a power interruption.

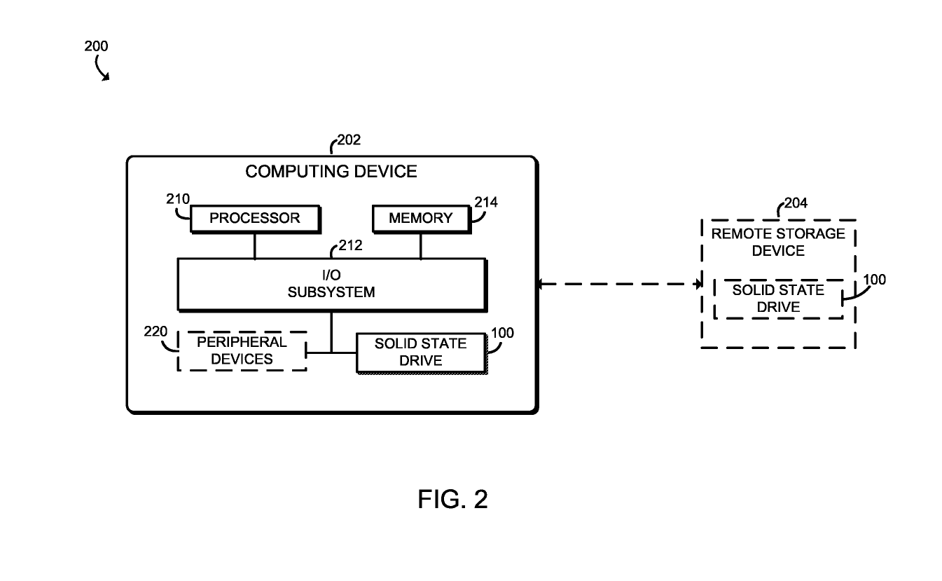

Referring now to FIG. 2, in some embodiments, the solid state drive 100 may form a portion of a computing system 200. For example, the solid state drive 100 may be incorporated into a computing device 202 and/or a remote storage device 204, which may be coupled to the computing device 202. The computing device 202 may be embodied as any type of computing device capable of communicating with the solid state drive 100 and/or the remote storage device 204 to access data stored on the solid state drive 100. For example, the computing device 202 may be embodied as a desktop computer, a mobile computing device, a notebook computer, a laptop computer, an enterprise computing system, a server, a server controller, a router, a switch, a smart appliance, a distributed computing system, a multiprocessor system, and/or any other computing device. As shown in FIG. 2, the illustrative computing device 202 includes a processor 210, an I/O subsystem 212, and memory 214. In some embodiments, the computing device 202 may include the solid state drive 100 as a component of the device 202. Additionally, the computing device 202 may include additional peripheral devices 220 in some embodiments. Of course, the computing device 202 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 214, or portions thereof, may be incorporated in the processor 210 in some embodiments.

The processor 210 may be embodied as any type of processor capable of performing the functions described herein. For example, the processor 210 may be embodied as a single or multi-core processor(s), digital signal processor, microcontroller, or other processor or processing/controlling circuit. Similarly, the memory 214 may be embodied as any type of volatile or non-volatile memory or data storage capable of performing the functions described herein. The memory 214 is communicatively coupled to the processor 210 via the I/O subsystem 212, which may be embodied as circuitry and/or components to facilitate input/output operations with the processor 210, the memory 214, the solid state drive 100 (in embodiments in which the solid state drive 100 forms a portion of the computing device 202), and other components of the computing device 202. For example, the I/O subsystem 212 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The remote storage device 204 may be embodied as any type of data storage device capable of operating remotely from the computing device 202. For example, the remote storage device 204 may be embodied as a remote data server, remote computing device, and/or other electronic device capable of managing access requests to the local solid state drive 100. In some embodiments, for example, the remote storage device 204 may be embodied as a remote data server with which the computing device 202 communicates to access data stored on the solid state drive 100 of the remote storage device 204.

Referring now to FIG. 3, in use, the solid state drive 100 may establish an environment 300. The illustrative environment 300 includes a reserved high-performance region management module 302, a reserved high-performance region notification module 304, a shutdown module 306, and a power failure management module 308. Each of the modules and other components of the environment 300 may be embodied as firmware, software, hardware, or a combination thereof. For example the various modules, logic, and other components of the environment 300 may form a portion of, or otherwise be established by, the drive controller 102 or other hardware components of the solid state drive 100. As such, in some embodiments, any one or more of the modules of the environment 300 may be embodied as a circuit or collection of electrical devices (e.g., a reserved high-performance region management circuitry, a reserved high-performance region notification circuitry, a shutdown circuitry, a power failure management circuitry, etc.)

The reserved high-performance region management module 302 is configured to manage the establishment and access of the reserved region in the volatile memory 120. To do so, the reserved high-performance region management module 302 includes a reservation module 310 and an access management module 312. The reservation module 310 is configured to establish a reserved memory region 320 in the volatile memory 120 upon power up of the solid state drive 100. To do so, the reservation module 310 may identify the region of the volatile memory 120 corresponding to the reserved region 320. For example, the reservation module 310 may identify the logical block addressing (LBA) range corresponding to the reserved region 320 and/or a namespace assigned to the reserved region 320. Upon establishment of the reserved region 320, the reservation module 310 may update a logical-to-physical indirection table 322, which may also be stored in the volatile memory 120 during operation of the solid state drive 100. In some embodiments, the reservation module 310 may also perform some pre-initialization of the reserved region 320. For example, the reservation module 310 may pre-erase the reserved region 320. Additionally, the reservation module 310 may reinstate data to the reserved region 320 that was previously copied to the non-volatile memory 110 in response to a power-down request or a power failure as discussed in more detail below.

The access management module 312 is configured to manage access to the reserved region 320 of the volatile memory 120. For example, a host 350 may request read or write access to the reserved region 320, which is handled by the access management module 312. Read and write requests that are not specifically addressed to the reserved region 320 are directed to the non-volatile memory 110 in the normal manner.

The reserved high-performance region notification module 304 is configured to provide notification to a host 350 (e.g., host applications or devices) that the reserved region 320 of the volatile memory 120 is available for use. Such notification may be embodied as any type of notification or data capable of informing a recipient of the existence of the reserved region 320 and providing access thereto. For example, in some embodiments, the reserved high-performance region notification module 304 may provide the assigned namespace associated with the reserved region 320 or the LBA range corresponding to the reserved region 320.

The shutdown module 306 is configured to respond to shutdown requests received by the solid state drive 100 from a host 350. To do so, the shutdown module 306 is configured to copy data presently saved in the reserved region 320 of the volatile memory 120 to the non-volatile memory 110 upon receipt of the shutdown request. Additionally, the shutdown module 306 may update the logical-to-physical indirection table 322 in response to moving the saved data to the non-volatile memory 110 and/or respond to the shutdown request upon successfully moving the data to the non-volatile memory 110.

The power failure management module 308 is configured to monitor for unexpected power failures or interruption and provide backup power to components of the solid state drive 100 for a period of time in the event of a power failure or interruption. Additionally, the power failure management module 308 and/or the shutdown module 306 may be configured to move data presently saved in the reserved region 320 to the non-volatile memory 110 in response to the power failure and while the backup power is supplied in order to properly save the data. As discussed above, because an increased amount of data may be saved in the reserved region 320, the power failure management module 308 may be configured to provide an increased amount of power and/or provide power for a longer period of time relative to typical solid date drives to allow the drive controller 102 to fully move the data from the reserved region 320 to the non-volatile memory 110.

As discussed above, the reserved high-performance region management module is configured to respond to storage access requests received from a host 350. The host 350 may be embodied as any type of device or service requesting a read or write access to the solid state drive 100. For example, in some embodiments, the host 350 may be embodied as a software application executed by the computing device 202.

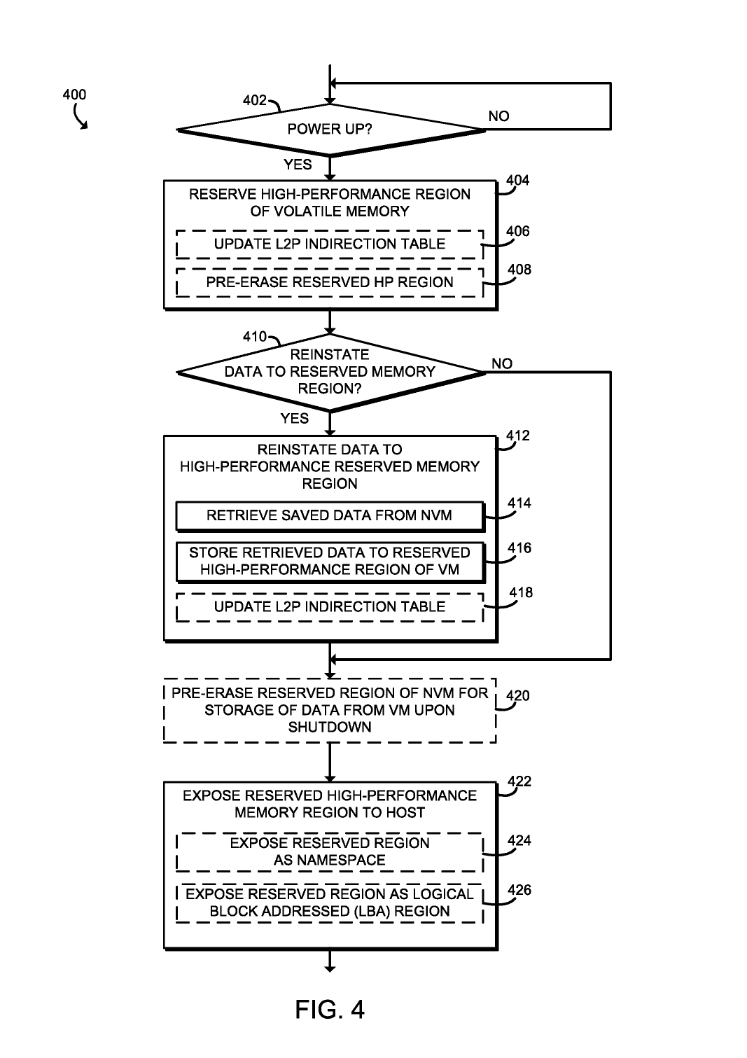

Referring now to FIG. 4, in use, the drive controller 102 of the solid state drive 100 may execute a method 400 for initializing the volatile memory 120. The method 400 begins with block 402 in which the drive controller 102 determines whether the solid state drive 100 has been powered up. If so, the method 400 advances to block 404 in which the drive controller 102 reserves the high-performance region 320 in the volatile memory 120. To do so, as discussed above, the drive controller 102 may determine or identify the region of the volatile memory 120 corresponding to the reserved region 320. For example, the drive controller 102 may identify the LBA range or a namespace corresponding to the reserved region 320. In some embodiments, the drive controller 102 may also update the logical-to-physical indirection table 322 in block 406 to indicate the presence of the reserved region 320 of the volatile memory 120. Additionally, in block 408, the drive controller 102 may pre-erase the physical memory of the volatile memory 120 corresponding to the reserved region 320.

After the reserved region 320 has been established in block 404, the method 400 advances to block 410 in which the drive controller 102 determines whether to reinstate data to the reserved region 320 that had been previously moved from the reserved region 320 to the non-volatile memory 110 in response to a shutdown request or a power failure. If so, the method 400 advances to block 412 in which the drive controller 102 reinstates the previously moved data to the reserved region 320 of the volatile memory 120. To do so, in block 414, the drive controller 102 retrieves the relevant data from the non-volatile memory 110. The drive controller 102 may be configured to identify the relevant data based on entries in the logical-to-physical indirection table 322, based on metadata saved in association with the relevant data, based on whether the data is stored in pre-defined locations of the non-volatile memory 110, and/or other criteria. Subsequently, in block 416, the drive controller 102 saves the retrieved data in the reserved region 320 of the volatile memory 120. Additionally, in some embodiments, the drive controller 102 may update the logical-to-physical indirection table 322 in block 418. Further, in some embodiments, the drive controller 102 may pre-erase remaining sections of the reserved region 320 (i.e., memory regions unused by the moved data) in block 420.

After the previously moved data has been reinstated in block 412 or if no reinstatement is needed, the method 400 advances to block 422. In block 422, the drive controller 102 exposes the reserved region 320 to a host 350 (or multiple hosts). To do so, the drive controller 102 may utilize any suitable methodology to expose the reserved region 320 for use by a host 350. For example, in block 424, the drive controller 102 may provide a notification or, otherwise expose, a namespace corresponding to the reserved region 320. Additionally or alternatively, in block 426, the drive controller 102 may provide a notification or, otherwise expose, a LBA range corresponding to the reserved region 320.

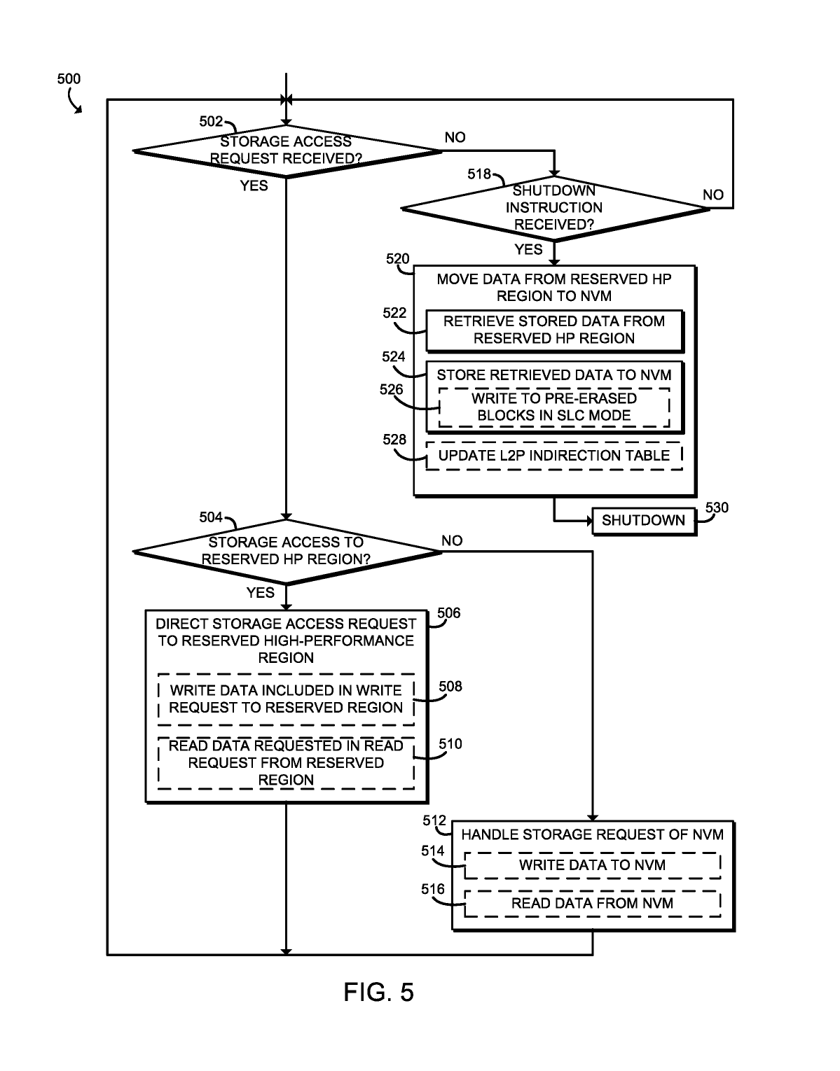

Referring now to FIG. 5, in use, the drive controller 102 may also execute a method 500 for managing storage access requests received by the solid state drive 100. The method 500 begins with block 502 in which the drive controller 102 determines whether a storage access request has been received. If so, the method 500 advances to block 504 in which the drive controller 102 determines whether the storage access request is directed to the reserved region 320 of the volatile memory 120. If so, the method 500 advances to block 506 in which the drive controller 102 directs the memory access to the reserved region 320. For example, in block 508, the drive controller 102 may write data included in a write request to the reserved region 320 of the volatile memory 120. Alternatively, in block 510, the drive controller 102 may read data requested in a read request from the reserved region 320 of the volatile memory 120.

Referring back to block 504, if the received storage access request is not directed to the reserved region 320 of the volatile memory 120, the drive controller 102 handles the storage access request to the non-volatile memory 110 as normal in block 512. For example, in block 514, the drive controller 102 may write data included in a write request to the non-volatile memory 110. Alternatively, in block 516, the drive controller 102 may read data requested in a read request from the non-volatile memory 110.

After the drive controller 102 has responded to the storage access request of the reserved region 320 in block 506 or the non-volatile memory 110 in the block 512, the method 500 loops back to block 502 in which the drive controller 102 continues to monitor for storage access requests. If no storage access request is received in block 502, the method 500 advances to block 518 in which the drive controller 102 determines whether a shutdown request has been received. If so, the method 500 advances to block 520. In block 520, the drive controller 102 moves data presently stored in the reserved region 320 of the volatile memory 120 to the non-volatile memory 110. To do so, the drive controller 102 retrieves the data stored in the reserved region 320 in block 522 and stores the retrieved data in the non-volatile memory 110 in block 524. In some embodiments, in block 528, the drive controller 102 may write the retrieved data to pre-erased blocks of memory of the non-volatile memory 110 configured in single-level cell (SLC) mode, which exhibits faster memory access and reliability relative to memory regions configured in multi-level cell (MLC) or triple-level cell (TLC) mode. Additionally, in some embodiments, the drive controller 102 may update the logical-to-physical indirection table 322 in block 528 based on the movement of the data from the reserved region 320 to the non-volatile memory 110. Regardless, after the data presently stored in the reserved region 320 has been successfully moved to the non-volatile memory 110, the drive controller 102 may shutdown the solid state drive 100 in block 530.

Referring now to FIG. 600, in use, the power fail response circuit 130 of the solid state drive 100 may execute a method 600 for handling and responding to an unexpected power failure or interruption. The method 600 begins with block 602 in which the power fail response circuit 130 determines whether a power failure or interruption has been detected. If so, the method 600 advances to block 604 in which the power fail response circuit 130 provides backup power to components of the solid state drive 100, such as the drive controller 102, the non-volatile memory 110, and the volatile memory 120. For example, in block 606, the power fail response circuit 130 may supply power to such components from the energy storage 132, which may be embodied as a bank of capacitors or batteries as discussed above.

In response to the backup power, the drive controller 102 is configured to move data presently stored in the reserved region 320 of the volatile memory 120 to the non-volatile memory 110 in block 608. To do so, the drive controller 102 retrieves the data stored in the reserved region 320 in block 610 and stores the retrieved data in the non-volatile memory 110 in block 612. As discussed above in regard to block 528 of the method 500 (see FIG. 5), the drive controller 102 may write the retrieved data to pre-erased blocks of memory of the non-volatile memory 110 configured in single-level cell (SLC) mode. Additionally, in some embodiments, the drive controller 102 may update the logical-to-physical table 322 in block 614 based on the movement of the data from the reserved region 320 to the non-volatile memory 110. Regardless, after the data presently stored in the reserved region 320 has been successfully moved to the non-volatile memory 110, the power fail response circuit 130 may power down the solid state drive 100 by removing the backup power from the powered components of the drive 100 in block 616.

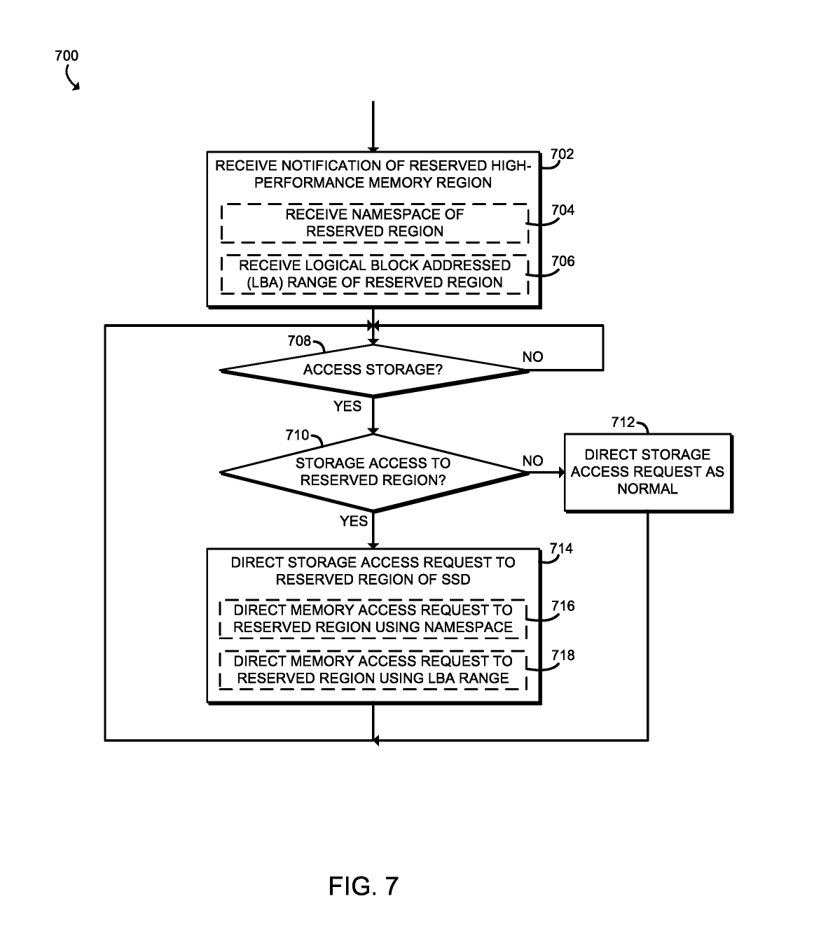

Referring now to FIG. 7, in use, the host 350 may execute a method 700 to access the reserved high-performance memory region 320 of the volatile memory 120 of the solid state drive 100. The method 700 begins with block 702 in which the host 350 receives a notification from the solid state drive 100 informing of the establishment of the reserved region 320 in the volatile memory 120. As discussed above, such notification may include or otherwise identify the namespace assigned to the reserved region 320 in block 704 and/or the LBA range corresponding to the reserved region 320 in block 706.

Subsequently, in block 708, the host 350 determines whether access to the memory of the solid state drive 100 (i.e., to the non-volatile memory 110 or the reserved region 320 of the volatile memory 120) is desired. If so, the method 700 advances to block 710 in which the host 350 determines whether access to the reserved region 320 is required. As discussed above in detail, the host 350 may utilize the reserved region 320 for important and/or time-critical memory storage activities including, for example, journaling or logging of data. If access to the reserved region 320 is not required, the method 700 advances to block 712 in which the host 350 directs the storage access request to the non-volatile memory 110 as normal. However, if access to the reserved region 320 is required, the method 700 advances to block 714 in which the host 350 directs the storage access request to the reserved region 320 of the volatile memory 120. For example, the host 350 may direct the storage access request using the namespace assigned to the reserved region 320 in block 716 and/or the LBA range corresponding to the reserved region 320 in block 718. It should be appreciated that such storage access requests may be embodied as read and/or write requests. Regardless, after the host 350 has directed the storage access request to the reserved region 320 in block 714 or to the non-volatile memory 110 in block 712, the method 700 loops back to block 708 in which the host 350 determines whether additional storage access requests are desired.

Although access to the reserved region 320 of the volatile memory 120 by the host 350 has been described above in regard to use of an assigned namespace or corresponding LBA range, it should be appreciated that other technologies and methodologies may be used to expose the reserved region 320 to the host(s) 350. For example, in some embodiments, the reserved region 320 may be memory mapped using Peripheral Component Interconnect express (PCIe) Base Address Registers (BAR). Such embodiments support saving data to the reserved region 320 with small granularity (e.g., per-byte) by a host 350 (e.g., a software application).

Additionally, although the non-volatile memory 110 has been described herein as supporting direct memory access to store and retrieve data therefrom, the non-volatile memory 110 may be used only for saving data from the reserved region 320 in response to a shutdown request or a power failure event in some embodiments. In such embodiments, the volatile memory 120 may have a substantially similar data capacity as the non-volatile memory 110 (e.g., the non-volatile memory 110 may be reduced to the size of the volatile memory 120 or vice-versa). Additionally, in such embodiments, all storage access requests to the solid state drive 100 would be directed to reserved region 320 of the volatile memory 120 as it would be the only memory region of the solid state drive 100 exposed to the host(s) 350.

### EXAMPLES

Illustrative examples of the technologies disclosed herein are provided below. An embodiment of the technologies may include any one or more, and any combination of, the examples described below.

Example 1 includes a solid state drive for managing a high-performance memory region, the solid state drive comprising a non-volatile memory; a volatile memory; and a drive controller to (i) reserve a region of the volatile memory for storage of host data, (ii) receive a storage access request from a host of a computing system, (iii) determine whether the storage access request is directed to the reserved region of the volatile memory, and (iv) access the reserved region of the volatile memory in response to a determination that the storage access request is directed to the reserved region.

Example 2 includes the subject matter of Example 1, and wherein the drive controller is further to expose the reserved memory region to the host of the computing system.

Example 3 includes the subject matter of any of Examples 1 and 2, and wherein to expose the reserved memory region comprises to inform the host of a namespace corresponding to the reserved memory region of the volatile memory.

Example 4 includes the subject matter of any of Examples 1-3, and wherein to expose the reserved memory region comprises to inform the host of a logical block addressed region corresponding to the reserved region of the volatile memory.

Example 5 includes the subject matter of any of Examples 1-4, and wherein to expose the reserved memory region comprises to memory map the reserved memory region of the volatile memory for use by the host.

Example 6 includes the subject matter of any of Examples 1-5, and wherein to reserve the region of the volatile memory comprises to reserve a region of a dynamic random-access memory (DRAM) of the solid state drive.

Example 7 includes the subject matter of any of Examples 1-6, and wherein to reserve the region of the volatile memory comprises to update a logical-to-physical indirection table of the solid state drive based on the reserved region of the volatile memory.

Example 8 includes the subject matter of any of Examples 1-7, and wherein to determine whether the storage access request is directed to the reserved region of the volatile memory comprises to determine whether the storage access request includes an address that indicates the storage access request is for the reserved region of the volatile memory.

Example 9 includes the subject matter of any of Examples 1-8, and wherein to determine whether the storage access request is directed to the reserved region of the volatile memory comprises to determine whether the storage access request is directed to a logical block addressed region corresponding to the reserved region of the volatile memory.

Example 10 includes the subject matter of any of Examples 1-9, and wherein to access the reserved region of the volatile memory comprises to write data to or read data from the reserved region of the volatile memory in response to a determination that the memory access is directed to the reserved region.

Example 11 includes the subject matter of any of Examples 1-10, and wherein to access the reserved region of the volatile memory comprises to write data to one or more pre-erased blocks of memory of the reserved region of the volatile memory in a single-level cell mode in response to a determination that the memory access is directed to the reserved region.

Example 12 includes the subject matter of any of Examples 1-11, and wherein the drive controller is further to access the non-volatile memory in response to a determination that the storage access request is not directed to the reserved region of the non-volatile memory.

Example 13 includes the subject matter of any of Examples 1-12, and wherein the drive controller is further to reinstate data stored in the non-volatile memory to the reserved region of the volatile memory during an initialization procedure of the solid state drive.

Example 14 includes the subject matter of any of Examples 1-13, and wherein to reinstate data stored in the non-volatile memory to the reserved region of the volatile memory comprises to retrieve data stored in the non-volatile memory; store the data retrieved from the non-volatile memory to the reserved region of the volatile memory; and update a logical-to-physical indirection table of the solid state drive based on the storage of the data to the reserved region of the volatile memory.

Example 15 includes the subject matter of any of Examples 1-14, and wherein the drive controller is further to pre-erase a storage region of the non-volatile memory based on a storage capacity of the reserved region of the volatile memory.

Example 16 includes the subject matter of any of Examples 1-15, and wherein the drive controller is further to receive a shutdown request for the solid state drive; retrieve data stored in the reserved region of the volatile memory in response to the shutdown request; and store the data retrieved from the reserved region of the volatile memory to the storage region of the non-volatile memory of the solid state drive.

Example 17 includes the subject matter of any of Examples 1-16, and further including a power fail response circuit to (i) detect a power failure event of the solid state drive, (ii) provide power to the drive controller, the volatile memory, and the non-volatile memory in response to the detection of the power failure event for a period of time, (iii) retrieve, during the period of time, data stored in the reserved region of the volatile memory in response to the detection of the power failure event, and (iv) store, during the period of time, the data retrieved from the reserved region of the volatile memory to the storage region of the non-volatile memory of the solid state drive.

Example 18 includes a method for managing a high-performance memory region of a solid state drive, the method comprising reserving, by a drive controller of the solid state drive, a region of a volatile memory of the solid state drive for storage of host data; receiving, by the drive controller, a storage access request from a host of a computing system; determining, by the drive controller, whether the storage access request is directed to the reserved region of the volatile memory; and accessing, by the drive controller, the reserved region of the volatile memory in response to a determination that the storage access request is directed to the reserved region.

Example 19 includes the subject matter of Example 18, and further comprising exposing the reserved memory region to the host of the computing system.

Example 20 includes the subject matter of any of Examples 18 and 19, and wherein exposing the reserved memory region comprises informing, by the drive controller, the host of a namespace corresponding to the reserved memory region of the volatile memory.

Example 21 includes the subject matter of any of Examples 18-20, and wherein exposing the reserved memory region comprises informing, by the drive controller, the host of a logical block addressed region corresponding to the reserved region of the volatile memory.

Example 22 includes the subject matter of any of Examples 18-21, and wherein to exposing the reserved memory region comprises memory mapping the reserved memory region of the volatile memory for use by the host.

Example 23 includes the subject matter of any of Examples 18-22, and wherein reserving the region of the volatile memory comprises reserving a region of a dynamic random-access memory (DRAM) of the solid state drive.

Example 24 includes the subject matter of any of Examples 18-23, and wherein reserving the region of the volatile memory comprises updating a logical-to-physical indirection table of the solid state drive based on the reserved region of the volatile memory.

Example 25 includes the subject matter of any of Examples 18-24, and wherein determining whether the storage access request is directed to the reserved region of the volatile memory comprises determining whether the storage access request includes an address that indicates the storage access request is for the reserved region of the volatile memory.

Example 26 includes the subject matter of any of Examples 18-25, and wherein determining whether the storage access request is directed to the reserved region of the volatile memory comprises determining whether the storage access request is directed to a logical block addressed region corresponding to the reserved region of the volatile memory.

Example 27 includes the subject matter of any of Examples 18-26, and wherein accessing the reserved region of the volatile memory comprises writing data to or reading data from the reserved region of the volatile memory in response to a determination that the memory access is directed to the reserved region.

Example 28 includes the subject matter of any of Examples 18-27, and wherein accessing the reserved region of the volatile memory comprises writing data to one or more pre-erased blocks of memory of the reserved region of the volatile memory in a single-level cell mode in response to a determination that the memory access is directed to the reserved region.

Example 29 includes the subject matter of any of Examples 18-28, and further including accessing, by the drive controller, non-volatile memory of the solid state drive in response to a determination that the storage access request is not directed to the reserved region of the non-volatile memory.

Example 30 includes the subject matter of any of Examples 18-29, and further including reinstating data stored in a non-volatile memory of the solid state drive to the reserved region of the volatile memory during an initialization procedure of the solid state drive.

Example 31 includes the subject matter of any of Examples 18-30, and wherein reinstating data stored in the non-volatile memory to the reserved region of the volatile memory comprises retrieving, by the drive controller, data stored in the non-volatile memory; storing, by the drive controller, the data retrieved from the non-volatile memory to the reserved region of the volatile memory; and updating, by the drive controller, a logical-to-physical indirection table of the solid state drive based on the storage of the data to the reserved region of the volatile memory.

Example 32 includes the subject matter of any of Examples 18-31, and further including pre-erasing a storage region of a non-volatile memory of the solid state drive based on a storage capacity of the reserved region of the volatile memory.

Example 33 includes the subject matter of any of Examples 18-32, and further including receiving, by the drive controller, a shutdown request for the solid state drive; retrieving, by the drive controller, data stored in the reserved region of the volatile memory in response to the shutdown request; and storing, by the drive controller, the data retrieved from the reserved region of the volatile memory to a non-volatile memory of the solid state drive.

Example 34 includes the subject matter of any of Examples 18-33, and further including detecting, by a power fail response circuit of the solid state drive, a power failure event of the solid state drive; providing, by the power fail response circuit, power to the drive controller, the volatile memory, and a non-volatile memory of the solid state drive in response to the detection of the power failure event for a period of time; retrieving, by the drive controller and during the period of time, data stored in the reserved region of the volatile memory in response to the detection of the power failure event; and storing, by the drive controller and during the period of time, the data retrieved from the reserved region of the volatile memory to a non-volatile memory of the solid state drive.

Example 35 includes one or more machine-readable storage media comprising a plurality of instructions stored thereon that, when executed, cause a solid state drive to perform the method of any of Examples 18-34.

Example 36 includes a solid state drive for managing a high-performance memory region, the solid state drive comprising means for reserving a region of a volatile memory of the solid state drive for storage of host data; means for receiving a storage access request from a host of a computing system; means for determining whether the storage access request is directed to the reserved region of the volatile memory; and means for accessing the reserved region of the volatile memory in response to a determination that the storage access request is directed to the reserved region.

Example 37 includes the subject matter of Example 36, and further including means for exposing the reserved memory region to the host of the computing system.

Example 38 includes the subject matter of any of Examples 36 and 37, and wherein the means for exposing the reserved memory region comprises means for informing the host of a namespace corresponding to the reserved memory region of the volatile memory.

Example 39 includes the subject matter of any of Examples 36-38, and wherein the means for exposing the reserved memory region comprises means for informing the host of a logical block addressed region corresponding to the reserved region of the volatile memory.

Example 40 includes the subject matter of any of Examples 36-39, and wherein to means for exposing the reserved memory region comprises means for memory mapping the reserved memory region of the volatile memory for use by the host.

Example 41 includes the subject matter of any of Examples 36-40, and wherein the means for reserving the region of the volatile memory comprises means for reserving a region of a dynamic random-access memory (DRAM) of the solid state drive.

Example 42 includes the subject matter of any of Examples 36-41, and wherein the means for reserving the region of the volatile memory comprises means for updating a logical-to-physical indirection table of the solid state drive based on the reserved region of the volatile memory.

Example 43 includes the subject matter of any of Examples 36-42, and wherein the means for determining whether the storage access request is directed to the reserved region of the volatile memory comprises means for determining whether the storage access request includes an address that indicates the storage access request is for the reserved region of the volatile memory.

Example 44 includes the subject matter of any of Examples 36-43, and wherein the means for determining whether the storage access request is directed to the reserved region of the volatile memory comprises means for determining whether the storage access request is directed to a logical block addressed region corresponding to the reserved region of the volatile memory.

Example 45 includes the subject matter of any of Examples 36-44, and wherein the means for accessing the reserved region of the volatile memory comprises means for writing data to or reading data from the reserved region of the volatile memory in response to a determination that the memory access is directed to the reserved region.

Example 46 includes the subject matter of any of Examples 36-45, and wherein the means for accessing the reserved region of the volatile memory comprises means for writing data to one or more pre-erased blocks of memory of the reserved region of the volatile memory in a single-level cell mode in response to a determination that the memory access is directed to the reserved region.

Example 47 includes the subject matter of any of Examples 36-46, and further including means for accessing non-volatile memory of the solid state drive in response to a determination that the storage access request is not directed to the reserved region of the non-volatile memory.

Example 48 includes the subject matter of any of Examples 36-47, and further including means for reinstating data stored in a non-volatile memory of the solid state drive to the reserved region of the volatile memory during an initialization procedure of the solid state drive.

Example 49 includes the subject matter of any of Examples 36-48, and wherein the means for reinstating data stored in the non-volatile memory to the reserved region of the volatile memory comprises means for retrieving data stored in the non-volatile memory; means for storing the data retrieved from the non-volatile memory to the reserved region of the volatile memory; and means for updating a logical-to-physical indirection table of the solid state drive based on the storage of the data to the reserved region of the volatile memory.

Example 50 includes the subject matter of any of Examples 36-49, and further including means for pre-erasing a storage region of a non-volatile memory of the solid state drive based on a storage capacity of the reserved region of the volatile memory.

Example 51 includes the subject matter of any of Examples 36-50, and further including means for receiving a shutdown request for the solid state drive; means for retrieving data stored in the reserved region of the volatile memory in response to the shutdown request; and means for storing the data retrieved from the reserved region of the volatile memory to a non-volatile memory of the solid state drive.

Example 52 includes the subject matter of any of Examples 36-51, and further including means for detecting a power failure event of the solid state drive; means for providing power to the drive controller, the volatile memory, and a non-volatile memory of the solid state drive in response to the detection of the power failure event for a period of time; means for retrieving, during the period of time, data stored in the reserved region of the volatile memory in response to the detection of the power failure event; and means for storing the data retrieved from the reserved region of the volatile memory to a non-volatile memory of the solid state drive.

1. A solid state drive for managing a high-performance memory region, the solid state drive comprising:
a non-volatile memory;
a volatile memory; and
a drive controller to (i) reserve a region of the volatile memory for storage of host data, (ii) receive a storage access request from a host of a computing system, (iii) determine whether the storage access request is directed to the reserved region of the volatile memory, and (iv) access the reserved region of the volatile memory in response to a determination that the storage access request is directed to the reserved region.

2. The solid state drive of claim 1 wherein the drive controller is further to expose the reserved memory region to the host of the computing system.

3. The solid state drive of claim 1, wherein to determine whether the storage access request is directed to the reserved region of the volatile memory comprises to determine whether the storage access request includes an address that indicates the storage access request is for the reserved region of the volatile memory.

4. The solid state drive of claim 1, wherein to determine whether the storage access request is directed to the reserved region of the volatile memory comprises to determine whether the storage access request is directed to a logical block addressed region corresponding to the reserved region of the volatile memory.

5. The solid state drive of claim 1, wherein the drive controller is further to reinstate data stored in the non-volatile memory to the reserved region of the volatile memory during an initialization procedure of the solid state drive.

6. The solid state drive of claim 5, wherein to reinstate data stored in the non-volatile memory to the reserved region of the volatile memory comprises to:
retrieve data stored in the non-volatile memory;
store the data retrieved from the non-volatile memory to the reserved region of the volatile memory; and
update a logical-to-physical indirection table of the solid state drive based on the storage of the data to the reserved region of the volatile memory.

7. The solid state drive of claim 1, wherein the drive controller is further to pre-erase a storage region of the non-volatile memory based on a storage capacity of the reserved region of the volatile memory.

8. The solid state drive of claim 7, wherein the drive controller is further to:
receive a shutdown request for the solid state drive;
retrieve data stored in the reserved region of the volatile memory in response to the shutdown request; and
store the data retrieved from the reserved region of the volatile memory to the storage region of the non-volatile memory of the solid state drive.

9. The solid state drive of claim 7, further comprising a power fail response circuit to (i) detect a power failure event of the solid state drive, (ii) provide power to the drive controller, the volatile memory, and the non-volatile memory in response to the detection of the power failure event for a period of time, (iii) retrieve, during the period of time, data stored in the reserved region of the volatile memory in response to the detection of the power failure event, and (iv) store, during the period of time, the data retrieved from the reserved region of the volatile memory to the storage region of the non-volatile memory of the solid state drive.

10. One or more machine-readable storage media comprising a plurality of instructions stored thereon that, when executed, cause a solid state drive to:
reserve a region of a volatile memory of the solid state drive for storage of host data;
receive a storage access request from a host of a computing system;
determine whether the storage access request is directed to the reserved region of the volatile memory; and
access the reserved region of the volatile memory in response to a determination that the storage access request is directed to the reserved region.

11. The one or more machine-readable storage media of claim 10, wherein the plurality of instructions further cause the solid state drive to expose the reserved memory region to the host of the computing system.

12. The one or more machine-readable storage media of claim 10, wherein to determine whether the storage access request is directed to the reserved region of the volatile memory comprises to determine whether the storage access request includes an address that indicates the storage access request is for the reserved region of the volatile memory.

13. The one or more machine-readable storage media of claim 10, wherein the plurality of instructions further cause the solid state drive to reinstate data stored in a non-volatile memory of the solid state drive to the reserved region of the volatile memory during an initialization procedure of the solid state drive.

14. The one or more machine-readable storage media of claim 13, wherein to reinstate data stored in the non-volatile memory to the reserved region of the volatile memory comprises to:
retrieve data stored in the non-volatile memory;
store the data retrieved from the non-volatile memory to the reserved region of the volatile memory; and
update a logical-to-physical indirection table of the solid state drive based on the storage of the data to the reserved region of the volatile memory.

15. The one or more machine-readable storage media of claim 10, wherein the plurality of instructions further cause the solid state drive to pre-erase a storage region of a non-volatile memory of the solid state drive based on a storage capacity of the reserved region of the volatile memory.

16. The one or more machine-readable storage media of claim 15, wherein the plurality of instructions further cause the solid state drive to:
receive a shutdown request for the solid state drive;
retrieve data stored in the reserved region of the volatile memory in response to the shutdown request; and
store the data retrieved from the reserved region of the volatile memory to a non-volatile memory of the solid state drive.

17. The one or more machine-readable storage media of claim 15, wherein the plurality of instructions further cause the solid state drive to:
detect a power failure event of the solid state drive;
provide power to the drive controller, the volatile memory, and a non-volatile memory of the solid state drive in response to the detection of the power failure event for a period of time;
retrieve, during the period of time, data stored in the reserved region of the volatile memory in response to the detection of the power failure event; and
store, during the period of time, the data retrieved from the reserved region of the volatile memory to a non-volatile memory of the solid state drive.

18. A method for managing a high-performance memory region of a solid state drive, the method comprising:
reserving, by a drive controller of the solid state drive, a region of a volatile memory of the solid state drive for storage of host data;
receiving, by the drive controller, a storage access request from a host of a computing system;
determining, by the drive controller, whether the storage access request is directed to the reserved region of the volatile memory; and
accessing, by the drive controller, the reserved region of the volatile memory in response to a determination that the storage access request is directed to the reserved region.

19. The method of claim 18, further comprising exposing the reserved memory region to the host of the computing system.

20. The method of claim 18, wherein determining whether the storage access request is directed to the reserved region of the volatile memory comprises determining whether the storage access request includes an address that indicates the storage access request is for the reserved region of the volatile memory.

21. The method of claim 18, further comprising reinstating data stored in a non-volatile memory of the solid state drive to the reserved region of the volatile memory during an initialization procedure of the solid state drive.

22. The method of claim 21, wherein reinstating data stored in the non-volatile memory to the reserved region of the volatile memory comprises:
retrieving, by the drive controller, data stored in the non-volatile memory;
storing, by the drive controller, the data retrieved from the non-volatile memory to the reserved region of the volatile memory; and
updating, by the drive controller, a logical-to-physical indirection table of the solid state drive based on the storage of the data to the reserved region of the volatile memory.

23. The method of claim 18, further comprising pre-erasing a storage region of a non-volatile memory of the solid state drive based on a storage capacity of the reserved region of the volatile memory.

24. The method of claim 23, further comprising:
receiving, by the drive controller, a shutdown request for the solid state drive;
retrieving, by the drive controller, data stored in the reserved region of the volatile memory in response to the shutdown request; and
storing, by the drive controller, the data retrieved from the reserved region of the volatile memory to a non-volatile memory of the solid state drive.

25. The method of claim 23, further comprising:
detecting, by a power fail response circuit of the solid state drive, a power failure event of the solid state drive;
providing, by the power fail response circuit, power to the drive controller, the volatile memory, and a non-volatile memory of the solid state drive in response to the detection of the power failure event for a period of time;
retrieving, by the drive controller and during the period of time, data stored in the reserved region of the volatile memory in response to the detection of the power failure event; and
storing, by the drive controller and during the period of time, the data retrieved from the reserved region of the volatile memory to a non-volatile memory of the solid state drive.
